(19) United States
(12) Patent Application Publication
(10) Pub. No.: US 2024/0165740 A1
(43) Pub. Date: May 23, 2024

(54) METHODS FOR WELDING COMPONENTS OF BATTERY MODULES

(71) Applicant: JAGUAR LAND ROVER LIMITED, Whitley, Coventry, Warwickshire (GB)

(72) Inventors: Mo AL-BADANI, Coventry, Warwickshire (GB); Oliver BAILEY, Coventry, Warwickshire (GB); Paul HANEY, Coventry, Warwickshire (GB)

(21) Appl. No.: 18/551,158

(22) PCT Filed: Mar. 31, 2022
(86) PCT No.: PCT/EP2022/058702

§ 371 Date: Sep. 18, 2023

(30) Foreign Application Priority Data
Mar. 31, 2021 (GB) 2104575.2

(51) Int. Cl. B23K 26/21; B23K 26/06; B23K 26/082; B23K 101/34; B23K 101/36; B23K 103/04; B23K 103/12; B60L 50/60; B60R 16/033; H01M 50/213; H01M 50/516

(52) U.S. Cl. CPC B23K 26/21; B23K 26/0648; B23K 26/0665; B23K 26/082; H01M 50/213; H01M 50/516; B23K 2101/34; B23K 2101/36; B23K 2103/04; B23K 2103/12; B60L 50/60; B60R 16/033; H01M 2220/20

(57) ABSTRACT

The present invention disclosure relates to a method of welding a tab to a terminal of an electrical cell using an infra-red laser welding system. A first surface of the tab is placed in contact with the terminal of the electrical cell, and an infra-red laser is directed through at least one lens towards a second surface of the tab opposite the first surface. The laser welding system is controlled to produce a weld by directing the beam to follow a predetermined path. During welding, the beam is focussed in a plane between the first surface and the lens. In some embodiments, the beam may be focussed between the second surface and the lens. Advantageously, focussing the beam in this way has been found to reduce undesirable phenomena such as spatter and to produce more reliable welds than prior art methods.

### TECHNICAL FIELD

The present invention relates generally to methods for welding components of battery modules. In particular, but not exclusively, the invention relates to methods of welding a tab of a busbar component to a terminal of an electrical cell, especially to a terminal of a cylindrical cell. Aspects of the invention relate to a method of laser welding a tab to a terminal of an electrical cell, to a battery module, to a battery pack, and to a vehicle.

### INTRODUCTION

There has recently been increased interest in providing battery-powered vehicles, which has led to developments in vehicle battery, in particular vehicle traction battery technology. In the manufacture of vehicle traction batteries, it is often necessary to weld a large number of cells to one or more busbar assemblies. It is generally desirable to perform such welds as quickly and reliably as possible. Furthermore, certain designs of battery module require welds to be located on relatively small areas on the cells, which can make reliable welding more difficult.

Infrared laser welding systems are known to provide efficient and fast welding capabilities. However, welding of certain materials, for example copper, using infrared laser welding systems can be difficult because of the high reflectivity of the material at infrared wavelengths.

It is an object of embodiments of the invention to at least mitigate one or more of the problems of the prior art.

### SUMMARY OF THE INVENTION

According to an aspect of the invention for which protection is sought, there is provided a method of high speed welding a plurality of cell terminals to a plurality of tabs of one or more busbar components, using a laser welding system comprising a welding laser arranged to emit a laser beam for welding, and a scanning head comprising a plurality of movable mirrors arranged to direct the laser beam, the method comprising: positioning each of the tabs in contact with one or more of the terminals; positioning the scanning head at a first position relative to the tabs; welding a first group of tabs to the respective terminals by moving the plurality of mirrors to sequentially direct the laser beam of the laser welding system towards each of the tabs in the first group, to produce a first group of welds, wherein the scanning head is held at the first position during the production of the first group of welds; positioning the scanning head at a second position relative to the tabs; and welding a second group of tabs to the respective terminals by moving the plurality of mirrors to sequentially direct the laser beam of the laser welding system towards each of the tabs in the second group, to produce a second group of welds, wherein the scanning head is held at the second position during the production of the second group of welds. Advantageously, this allows the welds to be performed more quickly than could be achieved using prior art methods, because it is not necessary to move the scanning head after every weld.

It will be understood that the step of positioning the scanning head relative to the tabs can be achieved by moving either the scanning head, the tabs and associated cells, or both.

In an embodiment, the method comprises measuring a position of the group of tabs. Advantageously, this allows the required position of the scanning head to achieve the required first and second positions relative to the tabs to be accurately determined.

In an embodiment, the method comprises measuring a position of each respective tab within the group of tabs and adjusting a focus of the beam in dependence on the positions of the tabs.

In an embodiment, each of the first and second groups of tabs are welded to at least 10 cells. It will be understood that each tab within the first and second groups will be typically welded to a corresponding cell. However, in some embodiments, a single tab may be welded to more than one cell. For example, a single tab may be welded to the shoulder regions of two adjacent cells.

In an embodiment, the mirrors are controlled by respective galvanometers.

In an embodiment, the laser beam has a focussed spot size on the tabs of 10-50 microns, optionally 20-40 microns. Such a spot size can provide the required energy density to reliably generate a melt pool of suitable depth, and also ensures sufficient contact area on the weld. The laser beam may have a power of 500-1000 W.

In an embodiment, the welding system is arranged to control the beam to oscillate about a centreline of a predetermined path to produce each weld, wherein the oscillations comprise a first component in a direction parallel to the predetermined path and a second component in a direction normal to the predetermined path. The oscillations may have an amplitude of 0.1-0.5 mm, optionally 0.2-0.4 mm, and the frequency of the oscillations may be 300-700 Hz. Advantageously, oscillating the beam helps to spread the energy deposited during welding, and increases the weld area.

In an embodiment, the predetermined path is a loop of 8-12 mm perimeter length and/or the weld path is a circle of 2-4 mm diameter. Such a weld path may be well-suited to welding commercially-available cells such as 21700 cells to busbar tabs.

In an embodiment, the weld path is an incomplete loop or circle, optionally wherein the loop has a perimeter length of 6.5-8.5 mm and/or the circle or loop has a diameter of 2-4 mm. Advantageously, an incomplete loop avoids the risk of overpenetration or overheating in a region where the start and end of the path are in close proximity or overlap.

Optionally, the predetermined path has a constant curvature.

In an embodiment, the time taken to produce each weld is 80 milliseconds or less.

In an embodiment, the terminal is a steel terminal.

In an embodiment, the tab comprises copper. Optionally, the copper is plated with nickel or titanium.

In an embodiment, the cell is a cylindrical cell. Accordingly, a terminal of the cell, typically the positive terminal, may be defined by a cap in a central region of a first end surface. The other terminal, typically the negative terminal, may be defined by a casing of the cylindrical cell that covers the second end surface, the cylindrical surface between the first and second end surfaces, and a peripheral region of the first end surface. An electrically non-conductive gasket is typically provided between the first and second terminals.

According to another aspect of the invention for which protection is sought, there is provided a method of mechanically and electrically connecting a busbar component to a plurality of cells, wherein the busbar assembly comprises a plurality of tabs, the method comprising welding each of the tabs to one or more of the cells, according to a method as described above.

According to another aspect of the invention for which protection is sought, there is provided a battery module comprising a busbar component mechanically and electrically connected to a plurality of cylindrical cells according to a method as described above.

According to another aspect of the invention for which protection is sought, there is provided a battery pack comprising a plurality of battery modules as described above.

According to another aspect of the invention for which protection is sought, there is provided a vehicle comprising a battery module or a battery pack as described above.

According to another aspect of the invention for which protection is sought, there is provided a method of welding a tab to a cell terminal using a laser welding system comprising a single-mode infra-red laser, the method comprising: placing the tab in contact with the terminal of the cell; and welding the tab to the terminal by controlling a laser beam generated by the laser welding system to produce a weld path comprising a predetermined shape, wherein the laser welding system is configured to control the beam to oscillate about the weld path, wherein the oscillations comprise a first component in a direction parallel to the weld path and a second component in a direction normal to the weld path. Advantageously, such oscillations help to spread the weld energy over a wider area, thereby ensuring a strong weld is produced without risking overpenetration of the terminal.

In an embodiment, the laser beam has a spot size on the tab of 10-50 microns, optionally 20-40 microns. Advantageously, such a spot size helps to ensure that the required energy density is reached by the oscillating beam, whilst avoiding the risk of overpenetration or overheating.

In an embodiment, the weld path is substantially continuous.

In an embodiment, the weld path is a continuous loop.

In an embodiment, the first and/or second component of the oscillations has an

amplitude of 0.1-0.5 mm, optionally 0.2-0.4 mm.

In an embodiment, the oscillations have a frequency of 300-700 Hz.

In an embodiment, the welding system comprises one or more mirrors arranged to rotate to direct the beam, wherein at least one of the mirrors is arranged to rotate at a speed sufficient to cause the position of the beam on the tab to move at 100-200 mm/s. Advantageously, such a system is operable to produce welds at the required speed and to ensure that the beam moves at a speed that avoids overpenetration.

In an embodiment, the time taken to produce the weld is 80 milliseconds or less.

In an embodiment, the terminal is a steel terminal.

In an embodiment, the tab comprises copper.

In an embodiment, the tab is plated with nickel .

In an embodiment, the cell is a cylindrical cell. Accordingly, a terminal of the cell, typically the positive terminal, may be defined by a cap in a central region of a first end surface. The other terminal, typically the negative terminal, may be defined by a casing of the cylindrical cell that covers the second end surface, the cylindrical surface between the first and second end surfaces, and a peripheral region of the first end surface. An electrically non-conductive gasket is typically provided between the first and second terminals.

In an embodiment, the weld path has constant curvature.

In an embodiment, the weld path is a loop of 8-12 mm perimeter length, and/or wherein the weld path is a circle of 2-4 mm diameter.

In an embodiment, an inert atmosphere is provided at least in the vicinity of the tab and the terminal during the step of welding the tab to the terminal. Advantageously, this may help to prevent oxidation of the tab and/or the terminal.

In an embodiment, the method further comprises the step of measuring a position of the tab. Advantageously, this allows the required position of the scanning head and/or the focus of the beam to be accurately determined.

In an embodiment, the focal position of the laser beam is adjustable along a longitudinal axis of the beam.

In an embodiment, the laser welding system comprises a lens through which the laser beam passes, wherein the laser beam is an infra-red laser beam and wherein the tab comprises a first surface which is placed in contact with the terminal and a second surface opposite the first surface, wherein the laser beam is focussed in a plane between the lens and the first surface.

According to another aspect of the invention for which protection is sought, there is provided a method of mechanically and electrically connecting a busbar component to a plurality of cells, wherein the busbar assembly comprises a plurality of tabs, the method comprising welding each of the tabs to one or more of the cells, according to a method as described above.

In an embodiment, the welding system comprises a scanning head comprising a plurality of movable mirrors arranged to direct the laser beam, wherein the method comprises: positioning each of the tabs in contact with one or more of the terminals; positioning the scanning head at a first position relative to the tabs; welding a first group of tabs to the respective terminals by moving the plurality of mirrors to sequentially direct the laser beam of the laser welding system towards each of the tabs in the first group, to produce a first group of welds, wherein the scanning head is held at the first position during the production of the first group of welds; positioning the scanning head at a second position relative to the tabs; and welding a second group of tabs to the respective terminals by moving the plurality of mirrors to sequentially direct the laser beam of the laser welding system towards each of the tabs in the second group, to produce a second group of welds, wherein the scanning head is held at the second position during the production of the second group of welds.

According to another aspect of the invention for which protection is sought there is provided a battery module comprising a busbar component mechanically and electrically connected to a plurality of cylindrical cells according to a method as described above.

According to another aspect of the invention for which protection is sought there is provided a battery pack comprising a plurality of battery modules described above.

According to another aspect of the invention for which protection is sought there is provided a vehicle comprising a battery module or a battery pack as described above.

According to another aspect of the invention for which protection is sought there is provided a method of welding a tab to a terminal of an electrical cell using an infra-red laser welding system, wherein the tab has a first surface and a second surface opposite the first surface, the method comprising: placing the first surface of the tab in contact with the terminal of the electrical cell; and directing the laser through at least one lens towards the second surface of the tab; and welding the tab to the terminal by controlling the welding system to produce a weld, wherein the producing the weld comprises directing a laser beam to follow a predetermined path of the weld, wherein the laser beam is focussed in a plane between the first surface and the lens. Advantageously, focussing the beam in a plane between the first surface and the lens helps to increase the size of the pool of molten material inside the weld cavity, relative to the size of the “keyhole” created on the second surface by the beam, thereby reducing the proportion of the beam energy that is lost to reflection. This can help to reduce spatter, and makes the weld quality less sensitive to small changes in workpiece position.

In an embodiment the laser is focussed in a plane between the second surface and the lens, wherein the plane is 0-1 mm away from the second surface, optionally 0.01-1 mm or 0.1-1 mm away from the second surface.

In an embodiment, the laser beam has a focussed spot size of 10-50 microns.

In an embodiment, the welding system is arranged to control the beam to oscillate about a centreline of the predetermined path, wherein the oscillations comprise a first component in a direction parallel to the predetermined path and a second component in a direction normal to the predetermined path

In an embodiment, the oscillations have an amplitude of 0.1-0.5 mm, optionally 0.2-0.4 mm.

In an embodiment, the frequency of the oscillations is 300-700 Hz.

In an embodiment, the welding system comprises one or more mirrors arranged to move to direct the beam, wherein at least one of the mirrors is arranged to move at a speed sufficient to cause the position of the beam on the tab to move at 100-200 mm/s. Optionally, the mirrors are arranged to rotate. For example, each mirror may be controlled by a respective galvanometer.

In an embodiment, wherein the time taken to produce the weld is 80 milliseconds or less.

In an embodiment, the terminal is a steel terminal.

In an embodiment, the tab comprises copper.

In an embodiment, the copper is plated with nickel. Advantageously, the nickel plating may help to reduce reflection of the laser beam, and may reduce oxidation of the tab during and after the welding.

In an embodiment, the cell is a cylindrical cell. Accordingly, a terminal of the cell, typically the positive terminal, may be defined by a cap in a central region of a first end surface. The other terminal, typically the negative terminal, may be defined by a casing of the cylindrical cell that covers the second end surface, the cylindrical surface between the first and second end surfaces, and a peripheral region of the first end surface. An electrically non-conductive gasket is typically provided between the first and second terminals.

In an embodiment, the laser beam has a power of 500-1000 W.

In an embodiment, the predetermined path has a constant curvature.

In an embodiment, the weld path is a loop of 8-12 mm perimeter length, and/or the weld path is a circle of 2-4 mm diameter.

In an embodiment, the weld path is an incomplete loop or circle, optionally wherein the loop has a perimeter length of 8-12 mm and/or the circle has a diameter of 2-4 mm.

In an embodiment, an inert atmosphere is provided at least in the vicinity of the tab and the terminal during the step of welding the tab to the terminal.

The method may further comprise the step of measuring a position of the tab.

In an embodiment, the focal position of the laser beam is adjustable along a longitudinal axis of the beam.

According to another aspect of the invention for which protection is sought there is provided a method of mechanically and electrically connecting a busbar component to a plurality of cells, wherein the busbar assembly comprises a plurality of tabs, the method comprising welding each of the tabs to one or more of the cells, according to a method as claimed in any preceding claim.

In an embodiment, the welding system comprises a welding laser and a scanning head comprising a plurality of movable mirrors arranged to direct a laser beam produced by the welding laser, wherein the method comprises: positioning each of the tabs in contact with one or more of the terminals; positioning the scanning head at a first position relative to the tabs; welding a first group of tabs to the respective terminals by moving the plurality of mirrors to sequentially direct the laser beam towards each of the tabs in the first group, to produce a first group of welds, wherein the scanning head is held at the first position during the production of the first group of welds; positioning the scanning head at a second position relative to the tabs; and welding a second group of tabs to the respective terminals by moving the plurality of mirrors to sequentially direct the laser beam towards each of the tabs in the second group, to produce a second group of welds, wherein the scanning head is held at the second position during the production of the second group of welds.

According to another aspect of the invention for which protection is sought there is provided a battery module comprising a busbar component mechanically and electrically connected to a plurality of cylindrical cells according to a method as described above.

According to another aspect of the invention for which protection is sought there is provided a battery pack comprising a plurality of battery modules as described above.

According to another aspect of the invention for which protection is sought there is provided a vehicle comprising a battery module or a battery pack as described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only, with reference to the accompanying figures, in which:

FIGS. 1A-C show different views of a cylindrical cell that may be used in a vehicle battery module (PRIOR ART);

FIG. 2 shows a laser welding system (PRIOR ART);

FIG. 3 shows a schematic view of the shape of a beam used to weld a tab to a terminal of a cell in an embodiment of the present invention;

FIG. 4 shows a schematic view of the weld shape used to weld a tab to a terminal of a cell in an embodiment of the present invention;

FIG. 5 shows a laser welding system operable to produce welds connecting the tabs of a busbar component to the terminals of a plurality of groups of cells in an embodiment of the present invention;

FIG. 6 shows a flow chart illustrating a method of welding a plurality of tabs to respective terminals of a plurality of cells in an embodiment of the present invention; and

FIG. 7 shows a flow chart illustrating a method of welding a tab to a terminal of a cell in an embodiment of the present invention;

FIG. 8 shows a flow chart illustrating a method of welding a tab to a terminal of a cell in another embodiment of the present invention; and

FIG. 9 shows a vehicle in an embodiment of the present invention.

### DETAILED DESCRIPTION

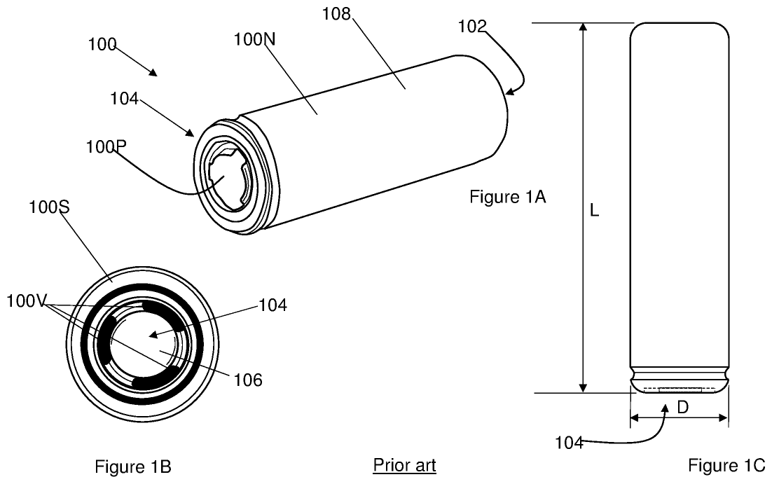

FIGS. 1A-C show different views of a conventional cylindrical cell 100. Cylindrical cells 100 are widely available in a variety of different sizes. For example, in traction batteries for vehicles cells having a diameter D of 21 mm and a length L of 70 mm are often used. Such cells are typically referred to as 21700 cells (the first two numbers referring to the diameter D, in mm, and the last three numbers referring to the length L, in tenths of mm). Flowever, it will be understood that other sizes of cell may also be used in embodiments of the present invention.

As will be well understood by the skilled person, the cell 100 comprises a positive terminal 100P, a negative terminal 100N, and vent means 100V. The positive terminal is provided by a steel end cap 106 in a central region of the first end 104 of the cell, and the negative terminal is provided by a steel cylindrical case 108. The steel cylindrical case 108 covers the second end 102, the entire cylindrical surface between the first and second ends, and a peripheral region 100S of the first end surface. The peripheral region of the first end surface may also be referred to as a “shoulder” region 100S of the first end surface 104. In commercially-available cells, it is sometimes the case that the end cap that defines the positive terminal 100P on the first end surface 104 protrudes beyond the shoulder region of the first end surface, although this is not the case in the cell shown in FIG. 1. This allows a substantially planar connector to be connected to the positive terminal and not the negative terminal. As will be well understood by the skilled person, it is important to avoid direct electrical connections between the positive and negative terminals, as such connections create a short circuit which may damage the cell.

As shown in FIG. 1, the cell 100 comprises three vent means 100V in the first end surface 104, between the steel end cap 106 that defines the positive terminal 100P and the shoulder region 100S of the steel cylindrical case 108. The vent means 100V are gaps that are covered by a material that will rupture to allow hot gases to escape through the gap between the end cap 106 and steel cylindrical case 108 in the event of excessive pressure occurring inside the cell, thereby mitigate against the risk of the cell exploding.

According to embodiments of the present invention, there are provided methods of welding a tab of a busbar component to a terminal of an electrical cell, especially to a terminal of a cylindrical cell, battery packs and battery modules produced by welding such tabs to terminals of electrical cells, and vehicles including such battery packs. In all cases, the cells may comprise cells as described above. The cells may have a negative terminal made from a steel cylindrical case having a thickness of approximately 0.2 mm in the cylindrical region, for example 0.1-0.3 mm. The bottom and shoulder regions of the case may have a thickness of approximately 0.4 mm, for example 0.3-0.5 mm. The positive terminal may also have a thickness of approximately 0.4 mm, for example 0.3-0.5 mm. Both terminals may include a nickel plating, which may have a thickness of approximately 2-5 microns.

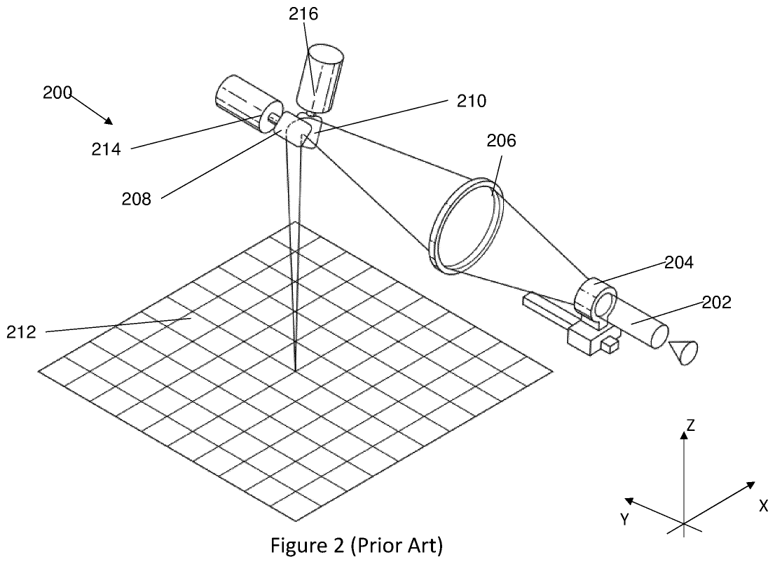

FIG. 2 shows a laser welding system 200. The system 200 comprises a high-powered laser (not shown), which produces a laser beam 202. Beam 202 passes through a diverging lens 204, and a converging lens 206, before being deflected towards a target location in the welding plane 212 by first and second mirrors 208, 210. Each of the mirrors 208, 210 is rotatable about a single axis under the control of a respective galvanometer 214, 216. The axes about which the mirrors 208, 210 are rotated about are mutually perpendicular, so that the first mirror 208 controls the target location of the beam in the X direction and the second mirror 210 controls the target location of the beam in the Y direction.

The lens 204 is movable along an axis parallel to the initial direction of the beam 202, which allows the position of the focal point of the laser, and therefore the welding plane, to be adjusted in the Z direction. It will be understood that the laser may be focused to provide a “spot” in the welding plane of a predetermined size. Furthermore, it will be understood that in some laser welding systems the lens 204 may be fixed, so that the focus position of the welding laser is not adjustable in the Z direction. Such systems are referred to as two-dimensional, as they are only operable to direct the beam in the X and Y directions.

A controller (not shown) is operable to control the power of the laser and to selectively turn the laser on or off. The controller is also operable to adjust the focal position by moving the lens 204, and to adjust the target position of the laser by controlling the angular positions of the mirrors first and second mirrors 208, 210, via the respective galvanometers 214, 216. Accordingly, an operator may program the controller to make a predetermined set of welds by actuating the laser only when it is directed at selected target regions. As will be well understood by the skilled person, laser welding systems such as the one illustrated in FIG. 2 are able to produce welds very rapidly and with fine control over the weld power and shape. They are therefore particularly useful in situations in which several components in close proximity must be rapidly welded together.

It will be understood that the lenses 204, 206 and the mirrors 208, 210 and associated galvanometers 214, 216 may all be contained within a common housing, which may have a suitable openings to receive the incoming beam and allow the focussed and directed beam to leave the housing. The arrangement of lenses and galvanometer-controlled mirrors shown in FIG. 2 may be referred to as a three-dimensional scanning head, because it is operable to move the focus position of the beam in three dimensions.

Although laser welding systems can employ laser beams having any suitable

wavelength, the present invention relates particularly, but not exclusively, to laser welding systems using infrared lasers. Such systems have typically been used for welding of plastics materials having relatively low reflectivity. Although they have also been used for welding of metals, the higher reflectivity of metals has limited their application. High reflectivity (or low absorption) can be a particular problem when the material to be welded is copper, because the reflectivity of copper at infrared wavelengths is particularly high.

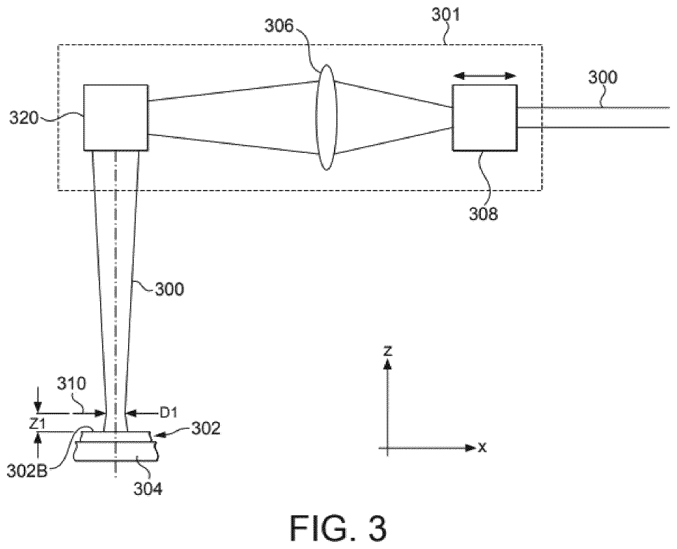

The present inventors have developed a procedure by which tabs formed from copper and/or other conductive materials having high reflectivity can be quickly and reliably welded to the terminals of electrical cells. FIG. 3 shows a schematic view of a scanning head 301 and a beam 300, which is used to weld a tab 302 to a terminal 304 of a cell. The tab 302 has a first surface 302A and a second surface 302B. The first surface 302A is in contact with an outer surface of the terminal 304 and the second surface 302B is opposite the first surface.

The focus position of beam 300 is adjusted along the Z axis by a diverging lens 308, which is movable, so as to move the focal position 310. The beam then passes through a fixed lens 306, and is subsequently directed towards the tab 302 by two galvanometer-controlled mirrors represented schematically by reference sign 320. The galvanometer-controlled mirrors may be similar to the mirrors 214, 216 shown in FIG. 2. It will be understood that the focal position 310 is the position at which the diameter of the beam D1 is at a minimum.

As shown in FIG. 3, the focal position of the beam 300 is above the second surface 302B of the tab 302. That is, the focal position is between the lens and the second surface. The distance Z1 between the second surface and the focal position may be up to 1 mm, for example between 0.01 mm and 1 mm. In some embodiments, the distance between the plane in which the beam 300 is focussed and the second surface 302B may be approximately equal to the Rayleigh length for the beam 300. As will be well understood by the skilled person, the Rayleigh length (also referred to as the Rayleigh range) refers to the distance between the narrowest point of a beam (i.e. the focus position) and the point at which its cross sectional area is doubled. Accordingly, the beam diameter in a plane that is offset from the focal point by a distance equal to the Rayleigh length will be approximately 1.41 (i.e. the square root of 2) times greater than the focussed spot diameter.

The spot that is present on the second surface 302B is therefore larger than the focussed spot size, and the beam diameter increases at a relatively high rate as the beam penetrates deeper into the tab 302 and subsequently the

cell terminal 304. The present inventors have recognised that this can be advantageous, because it increases the size of the pool of molten material inside the weld cavity, relative to the size of the “keyhole” created on the second surface by the beam, thereby reducing the proportion of the beam energy that is lost to reflection. Furthermore, because the beam diameter is increasing at a relatively high rate, overpenetration becomes less likely. This is because the beam energy is spread over a wider area as it penetrates further into the tab and the cell terminal. It has been observed that a beam with a focal position between the lens and the second surface reduces the amount of “spatter” that takes place during welding. It will be understood that the term “spatter” refers to the formation of drops of metal around the weld site due to ejection of molten metal from the weld pool. The conditions which cause weld spatter may also be associated with poor weld quality such as porosity and voids. Positioning the beam focus between the lens and the second surface has also been observed to make the welding operation more robust against small changes in the position of the tab.

It will be understood that a relatively small spot size on the second surface of tab 302 is generally required, in order to provide adequate energy density to initiate melting of the tab. In the illustrated embodiment, the focussed spot size is in the range of 10-50 microns, optionally approximately 30 microns. However, the offset between the focal position of the beam 300 and the second surface 302B of the tab results in a larger spot being present on the second surface of the tab. Accordingly, the spot size on the second surface 302B may be in the range of 14-70 microns, optionally around 42 microns.

In the illustrated embodiment, the tab 302 comprises a copper film having a thickness of 0.2-0.3 mm, with a nickel plating on the outside of the tab. The nickel plating has a thickness of approximately 0.5-2 microns, optionally around 1 micron. Advantageously, the nickel plating helps to prevent oxidation, and also helps the laser beam to form the initial keyhole in the tab, because nickel has a lower reflectivity at infrared wavelengths than copper.

As discussed above with respect to FIGS. 2 and 3, laser welding systems 200 having three-dimensional scanning heads are operable to control the focus position of a beam in three dimensions. Accordingly, the laser welding system 200 is operable to use the galvanometer scanners to direct the beam in the X and Y planes, and to move the focussing lens 204 to adjust the position of the plane in which the beam is focussed along the Z axis.

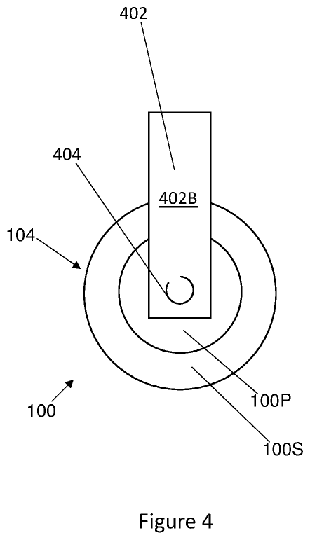

In an embodiment of the present invention, the laser welding system 200 may be controlled to maintain the focus of the beam in a plane that is between the lens and the second surface 302B, whilst the galvanometer scanners direct the beam in the XY plane to produce a weld having a weld shape 404 similar to that shown in FIG. 4.

FIG. 4 shows a tab 402, which is placed in contact with a positive terminal 100P of a cylindrical cell 100, prior to commencing welding of the tab 402 to the terminal 100P. In embodiments of the present invention, a weld having a predetermined shape such as the shape 404 shown in FIG. 4 is produced by controlling the spot on the second surface 402B to follow a weld path having a centreline that corresponds to the weld shape 404, but that also includes oscillations about the centreline of the weld path. In some embodiments the oscillations may be entirely in a direction normal to the centreline. However, it is optional for the oscillations to include a component that is parallel with the centreline and a component that is normal to the centreline. In the illustrated embodiment, the oscillations are circular oscillations, although other elliptical or non-elliptical oscillations having components parallel and normal to the centreline are also useful. Advantageously, the use of oscillations about the centreline of the weld path help to ensure that the energy is distributed over a larger area than would be the case if the spot was to be directed to simply follow the centreline of the weld shape.

In the embodiment illustrated in FIG. 4, the weld shape comprises a partial circle 404, having a diameter of 3 mm. It is advantageous for the circle to be partial rather than complete, because this helps to avoid overpenetration, which might otherwise occur during the welding of the last portion of the circle as a result of the portion of the tab to be welded having been heated up when the first portion of the circle was welded.

The circular oscillations about the centreline of the weld shape have an amplitude of 0.3 mm, and the frequency of the oscillations is approximately 500 Hz. In some embodiments, the frequency of the oscillations may be 300-700 Hz. The total length of the weld centreline is approximately 7.5 mm, and the average speed at which the spot moves along the centreline is approximately 140 mm/s. Accordingly, the time taken to produce the weld is approximately 54 milliseconds. It will be understood that it is an advantage of certain embodiments of the present invention that the time taken to produce an individual weld may be lower than could be achieved using prior art arrangements.

In alternative embodiments, the weld shape may comprise a complete circle, or a non-circular loop. The total circumference of the circle or loop may be 8-12 mm. The other welding parameters may be in the ranges described above.

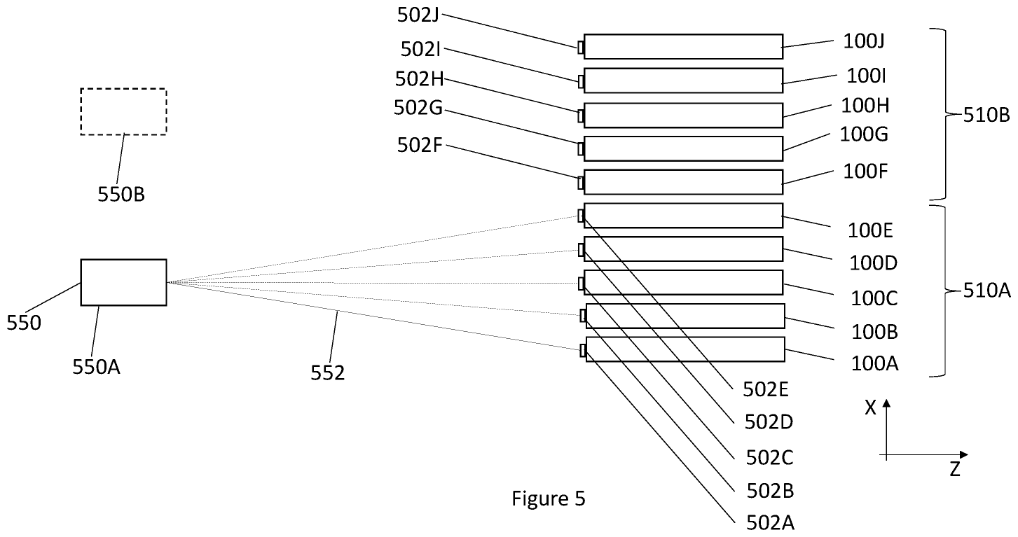

Another advantage of certain embodiments of the present invention is that the overall time taken to produce all of the welds connecting one or more busbar components to the terminals of a plurality of cells can be reduced. FIG. 5 shows a cross sectional view through a plurality of cells 100A-J, each having a terminal to be welded to a respective tab 502A-J by a laser emitted from a laser scanning head 550. It will be understood that the laser scanning head 550 is optionally a three-dimensional scanning head similar to the scanning head shown in FIG. 2, that is operable to control the direction and focus plane of a laser beam 552. However, in some embodiments a two-dimensional scanning head may be used, and the focus position along the Z axis may be adjusted solely by moving the scanning head and/or the cells. The ten cells 100A-J and corresponding tabs 502A-J shown in FIG. 5 are split into two groups 510A, 510B, the first group comprising cells 100A-E, and the second group comprising cells 100F-J. The scanning head 550 is operable to produce all of the required welds between the terminals and tabs within the first group when it is located at the first position 550A. Accordingly, there is no need to move the scanning head after each weld. The scanning head is also movable to a second position 550B, from which it is operable to produce all of the welds between the terminals and tabs in the second group of terminals and tabs 510B.

Although five cells and corresponding tabs are shown in each of the groups 51 OA, 51 OB, it will be understood that only a single XZ plane is shown, and that further cells that are offset in the Y direction are also present. In the illustrated embodiment, there are a total of fifteen cells in each of the groups 510A, 510B, with each group comprising an additional five cells that are offset from the cross section shown in the positive Y direction, and an additional five cells that are offset from the shown cross section in the negative Y direction. It will also be understood that other numbers of cells in each group are also useful.

As can be seen from FIG. 5, the length of the beam 552 changes in dependence on the X position of the cell terminal being welded. Accordingly, the focal position of the beam 552 along the length of the beam may be changed between welds to ensure a consistent distance between the focal position and the cell terminal and the associated tab. As will be well understood by the skilled person, the focus position along the centreline of the beam may be adjusted by moving a focussing lens such as the moving lens 308 shown in FIG. 3.

Producing several welds from a single position of the scanning head 550 helps to reduce the overall time needed to weld the tabs 502 to the respective terminals of the cells 504, because after a weld is completed there is no need to delay starting a subsequent weld until the movement of the scanning head 550 is complete.

As discussed above, in the embodiment shown in FIG. 5, a cross section through ten cells is shown, and two further rows of ten cells are present in offset planes. Accordingly, there are a total of 30 cells, which are split into two groups of 15 cells, each group being welded to the tabs of a busbar component from a different position of the scanning head. However, it will be understood that in some embodiments substantially more cells may be present. In one embodiment, a battery module may comprise more than 100 cells, for example approximately 300 cells. As such, the cells within a module may be split into several groups of cells for the welding of the tabs to the cell terminals, wherein each group comprises approximately 10-20 cells, optionally around 15 cells.

In some embodiments, a clamping fixture (not shown) may be provided to hold the tabs 502A-J in contact with the terminals of the respective cells during the welding operations. Such a clamping fixture must have appropriately-sized apertures to allow the laser beam 552 to pass through the clamping fixture and contact the tab clamped to the cell terminal. A single clamping fixture may be provided for all of the cells within a battery module, or a plurality of clamping fixtures may be used. Furthermore, the clamping fixture or fixtures may be large enough to simultaneously clamp all of the tabs to the respective terminals, or the fixture or fixtures may be moved between the welding operations. Optionally, any movement of the clamping fixture that is required will take place at the same time as the movement of the scanning head 550, so as to mitigate or avoid the introduction of any additional delay by the movement of the clamping fixture.

The individual welds between the tabs 502A-J and the terminals of the respective cells 102A-J may have a similar shape to that shown in FIG. 4. The welds may be produced be causing the spot from the laser beam to follow a weld path having oscillations about the centreline of a predetermined weld shape, as discussed above with respect to FIG. 4. In some embodiments, the oscillations may be entirely in a direction normal to the centreline of the weld shape. However, it is preferred that the oscillations have components both parallel to the weld shape and normal to the weld shape. For example, the oscillations may be elliptical oscillations.

The individual welds between the tabs 502A-J and the terminals of the respective cells 100A-J may also be produced with the focus position of the beam 552 between the second surface of the tab and the scanning head 550, as discussed above with respect to FIG. 3. Advantageously, focussing the beam between the second surfaces of the tabs 502A-J and the scanning head 550 may reduce the extent to which the beam spot is distorted on the tabs.

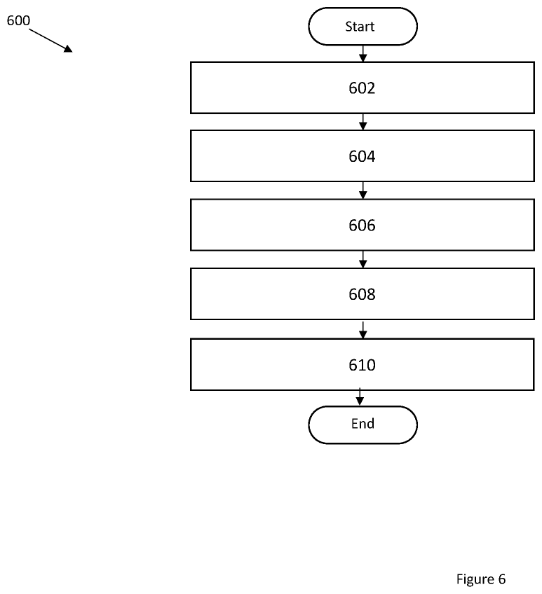

FIG. 6 shows a flow chart illustrating a method 600 of high-speed welding of a plurality of cell terminals to a plurality of tabs in an embodiment of the present invention. The method starts at step 602, in which each of the tabs is placed in contact with one or more of the terminals. One or more clamping fixtures may be provided to hold the tabs in contact with the terminals. The method then proceeds to step 604, in which the scanning head is positioned at a first position relative to the tabs. This is typically achieved by moving the scanning head, but in some embodiments the cells may be moved, or both the cells and the scanning head may be moved. The method then proceeds to step 606, in which a first group of tabs are welded to the respective terminals with the scanning head 550 held at the first position 550A. This is achieved by moving the plurality of mirrors to sequentially direct the laser beam of the laser welding system towards each of the tabs in the first group, to produce a first group of welds. After the first group of welds are complete, the method proceeds to step 608, in which the scanning head is positioned at a second position relative to the tabs. Again, the positioning of the scanning head is typically achieved by moving the scanning head, but could equally be achieved by moving the cells, or by moving both the cells and the scanning head. The method then proceeds to step 610, in which a second group of cells are welded to the respective terminals by moving the plurality of mirrors to sequentially direct the laser beam of the laser welding system towards each of the tabs in the second group, to produce a second group of welds. The scanning head is held at the second position during the production of the second group of welds.

The method may then end. However, in some embodiments, further groups of cells may be welded to the tabs of the busbar components, or to the tabs of different busbar components. In such embodiments, the method may continue with the scanning head being moved to third and possibly subsequent positions, and welding corresponding groups of cells to tabs from those positions.

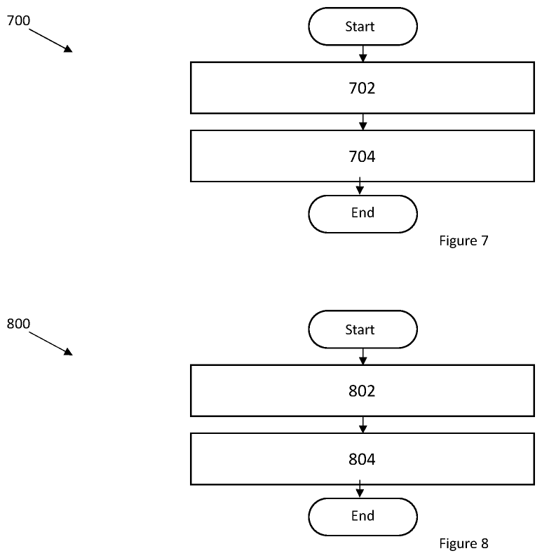

FIG. 7 shows a flow chart illustrating a method 700 for welding a tab to a cell terminal using a laser welding system comprising a single-mode infra-red laser.

The method 700 begins at step 702, in which the tab is placed in contact with the terminal of the cell. The method then proceeds to step 704, in which the tab is welded to the terminal by controlling a laser beam generated by the laser welding system to produce a weld path comprising a predetermined shape. During step 704, the laser welding system controls the beam to oscillate about the weld path, wherein the oscillations comprise a first component in a direction parallel to the weld path and a second component in a direction normal to the weld path. For example, the oscillations may be elliptical oscillations or circular oscillations. The method then ends.

It will be understood that the method of welding a tab to a cell terminal as shown in FIG. 7 may be applied when producing some or all of the individual welds in a method of welding a plurality of cell terminals to a plurality of tabs as shown in FIG. 6.

FIG. 8 shows a flow chart illustrating a method 800 for welding a tab to a terminal of an electrical cell in an embodiment of the present invention.

The method 800 begins at step 802, in which a first surface of the tab is placed in contact with the terminal of the electrical cell. The method then proceeds to step 804, in which a laser is directed through at least one lens towards a second surface of the tab. The second surface of the tab is opposite the first surface. The method then proceeds to step 804, in which the tab is welded to the terminal by controlling the welding system to make a weld. During step 804, the laser beam is focussed in a plane between the first surface and the lens, optionally between the second surface and the lens. The laser beam may be focussed in a plane between 0 and 1 mm away from the second surface, optionally between 0.01-1 mm away from the second surface.

It will be understood that the welding in the above-described methods may take place in an inert atmosphere. For example, the atmosphere surrounding the parts to be welded may have a very low oxygen concentration. In some embodiments, the atmosphere surrounding the parts to be welded may substantially consist of nitrogen, argon, or another inert gas.

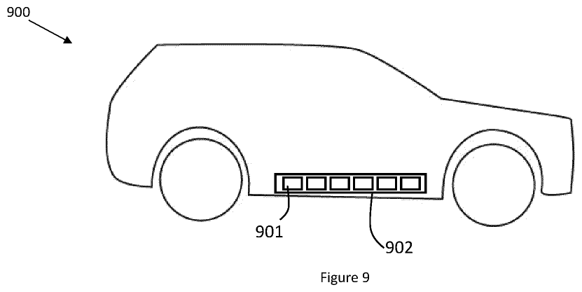

FIG. 9 shows a vehicle 900 in an embodiment of the present invention. One or more cells welded to tabs as discussed in the above embodiments may be incorporated into the vehicle 900. For example, the cells welded to tabs may form part of a battery module 901 within the vehicle 900. In some embodiments, a plurality of battery modules 901, each comprising cells welded to tabs as described above, may be incorporated into a battery pack 902 of the vehicle 900.

1. A method of welding a tab to a terminal of an electrical cell using an infra-red laser welding system, wherein the tab has a first surface and a second surface opposite the first surface, the method comprising:
placing the first surface of the tab in contact with the terminal of the electrical cell; and
directing a laser through at least one lens towards the second surface of the tab; and
welding the tab to the terminal by controlling the infra-red laser welding system to produce a weld, wherein the producing the weld comprises directing a laser beam to follow a predetermined path of the weld,
wherein the laser beam is focussed in a plane between the first surface and the at least one lens.

2. The method as claimed in claim 1, wherein the laser is focussed in a plane between the second surface and the lens, wherein the plane is 0-1 mm away from the second surface.

3. The method as claimed in claim 1, wherein the laser beam has a focussed spot size of 10-50 microns.

4. The method as claimed in claim 1, wherein the infra-red laser welding system is arranged to control the laser beam to oscillate about a centreline of the predetermined path, wherein the oscillations comprise a first component in a direction parallel to the predetermined path and a second component in a direction normal to the predetermined path.

5. The method as claimed in claim 1, wherein the infra-red laser welding system comprises one or more mirrors arranged to move to direct the laser beam, wherein at least one of the one or more mirrors is arranged to move at a speed sufficient to cause a position of the beam on the tab to move at 100-200 mm/s.

6. The method as claimed in claim 1, wherein time taken to produce the weld is 80 milliseconds or less.

7. The method as claimed in claim 1, wherein the terminal is a steel terminal.

8. The method as claimed in claim 1, wherein the tab comprises copper.

9. The method as claimed in claim 1, wherein the laser beam has a power of 500-1000 W.

10. The method as claimed in claim 1, wherein an inert atmosphere is provided at least in a vicinity of the tab and the terminal during the welding of the tab to the terminal.

11. The method as claimed in claim 1, further comprising measuring a position of the tab.

12. A method of mechanically and electrically connecting a busbar component to a plurality of cells, wherein the busbar assembly comprises a plurality of tabs, the method comprising welding each of the tabs to one or more of the cells, according to the method as claimed in claim 1;
wherein the method comprises:
positioning each of the tabs in contact with one or more of the terminals;
positioning the scanning head at a first position relative to the tabs;
welding a first group of tabs to the respective terminals by moving the plurality of mirrors to sequentially direct the laser beam towards each of the tabs in the first group, to produce a first group of welds, wherein the scanning head is held at the first position during the production of the first group of welds;
positioning the scanning head at a second position relative to the tabs; and
welding a second group of tabs to the respective terminals by moving the plurality of mirrors to sequentially direct the laser beam towards each of the tabs in the second group, to produce a second group of welds, wherein the scanning head is held at the second position during the production of the second group of welds.

13. A battery module comprising the busbar component mechanically and electrically connected to a plurality of cylindrical cells according to the method as claimed in claim 12.

14. A battery pack comprising the battery module as claimed in claim 13.

15. A vehicle comprising the battery module as claimed in claim 13.

16. A vehicle comprising the battery pack as claimed in claim 14.

17. The method as claimed in claim 4, wherein the oscillations have an amplitude of 0.1-0.5 mm, optionally 0.2-0.4 mm.

18. The method as claimed in claim 4, wherein a frequency of the oscillations is 300-700 Hz.

19. The method as claimed in claim 8, wherein the copper is plated with nickel.

20. The method as claimed in claim 12, wherein the infra-red laser welding system comprises a welding laser and a scanning head comprising a plurality of movable mirrors arranged to direct a laser beam produced by the welding laser.
